(19) United States
(12) Patent Application Publication
(10) Pub. No.: US 2024/0333460 A1
(43) Pub. Date: Oct. 3, 2024

(54) METHODS AND APPARATUSES FOR M-TRP BASED TRANSMISSION

(71) Applicant: LENOVO (BEIJING) LIMITED, BEIJING (CN)

(72) Inventors: LINGLING XIAO, BEIJING (CN); BINGCHAO LIU, BEIJING (CN); CHENXI ZHU, FAIRFAX, VA (US); WEI LING, BEIJING (CN); YI ZHANG, BEIJING (CN)

(21) Appl. No.: 18/293,290

(22) PCT Filed: Jul. 28, 2021
(86) PCT No.: PCT/CN2021/108995

§ 371 Date: Jan. 29, 2024

(51) Int. Cl. H04L 5/00; H04W 72/232

(52) U.S. Cl. CPC H04L 5/0053; H04W 72/232

(57) ABSTRACT

Embodiments of the present disclosure relate to methods and apparatuses for multiple transmit-receive point (M-TRP) based transmission. According to an embodiment of the present disclosure, a method can include: receiving configuration information of a first sounding reference signal (SRS) resource set and a second SRS resource set for a physical uplink shared channel (PUSCH) transmission, wherein each of the first SRS resource set and the second SRS resource set includes at least one SRS resource; and determining a first bit width of a first SRS resource indicator (SRI) field and a second bit width of a second SRI field in downlink control information (DCI), wherein the first bit width is determined based on a maximum number of SRS resource(s) configured in the first SRS resource set and the second SRS resource set. Embodiments of the present disclosure can reduce the overhead in DCI while considering the dynamic switching between S-TRP and M-TRP based PUSCH transmissions.

### TECHNICAL FIELD

Embodiments of the present application generally relate to wireless communication technology, and in particular to methods and apparatuses for multiple transmit-receive point (M-TRP) based transmission.

### BACKGROUND

M-TRP based transmission has been introduced into New Radio (NR). In NR Rel-17, it is proposed to identify and specify features to improve reliability and robustness for channels besides a physical downlink shared channel (PDSCH), e.g., physical downlink control channel (PDCCH), physical uplink shared channel (PUSCH), and physical uplink control channel (PUCCH), using multiple transmit-receive points (TRPs) and/or multiple panels, with Rel-17 reliability features.

In Rel-15 or Rel-16, for a single TRP (S-TRP) based PUSCH transmission, a single sounding reference signal (SRS) resource set for codebook and/or non-codebook based PUSCH transmission may be configured to a user equipment (UE). In addition, an SRS resource indicator (SRI) field in downlink control information (DCI) format 0_1 or DCI format 0_2 may be used to indicate the SRS resource(s) in the single SRS resource set used for the PUSCH transmission and to indicate the number of layers of the PUSCH transmission for a non-codebook based PUSCH transmission. The bit width of the SRI field is determined based on the number of SRS resources within the single SRS resource set.

For a codebook based PUSCH transmission, a base station (BS) will indicate a precoding matrix from a pre-defined codebook to a UE, e.g., the precoding matrix is indicated based on the SRS resource(s) in the single SRS resource set configured to the UE, and the UE will apply the precoding matrix to a scheduled PUSCH transmission. For a non-codebook based PUSCH transmission, the UE shall first transmit the SRS resource(s) within the single SRS resource set to the BS, wherein each SRS resource is transmitted with a different precoding matrix calculated by the UE. Then, the BS may indicate one or more SRS resources by an SRI field in DCI to the UE for a scheduled PUSCH transmission, and then the UE may apply the same precoding matrix(es) as those for the indicated one or more SRS resources to the scheduled PUSCH transmission.

In Rel-17, two SRS resource sets may be configured for a UE to support M-TRP PUSCH repetition transmission and two SRI fields may be used. When different numbers of SRS resources are configured for two SRS resource sets, how to determine the bit width of each SRI field by considering the dynamic switching between S-TRP based PUSCH transmission and M-TRP based PUSCH transmission is needed to be addressed.

In addition, in Rel-16, an open loop power control (OLPC) parameter (e.g., a parameter “P0” or “P0-PUSCH-r16” as specified in 3GPP standard documents which configures the target receiving power at a BS) for a PUSCH transmission can be indicated by an OLPC filed in DCI format 0_1 or DCI format 0_2, and the bit width of the OLPC field depends on whether an SRI field is present in the DCI. However, in Rel-17, when two SRS resource sets are configured but only one SRI field is present (i.e. there is only one SRI field whose bit width is no less than 1 bit) in DCI format 0_1 or DCI format 0_2, how to determine the bit width of an OLPC filed is also needed to be addressed.

Given the above, it is desirable to provide improved technology for M-TRP based PUSCH transmission, which can resolve the above issues caused by the imbalance numbers of SRS resource(s) between different TRPs.

### SUMMARY OF THE APPLICATION

Some embodiments of the present application provide a technical solution for M-TRP based transmission.

According to some embodiments of the present application, a method performed by a UE may include: receiving configuration information of a first SRS resource set and a second SRS resource set for a PUSCH transmission, wherein each of the first SRS resource set and the second SRS resource set includes at least one SRS resource; and determining a first bit width of a first SRI field and a second bit width of a second SRI field in DCI, wherein the first bit width is determined based on a maximum number of SRS resource(s) configured in the first SRS resource set and the second SRS resource set, N_{m,SRS}.

In some embodiments of the present application, the method may further includes: receiving a PUSCH mode field in the DCI indicating whether the PUSCH transmission is transmitted according to the first SRS resource set, the second SRS resource set, or both the first SRS resource set and the second SRS resource set.

In some embodiments of the present application, the second bit width is determined based on N_{m,SRS}.

In some embodiments of the present application, in the case that the PUSCH transmission is a codebook based PUSCH transmission, the first bit width and the second bit width are determined by ┌log₂(N_{m,SRS})┐.

In some embodiments of the present application, in the case that the PUSCH transmission is a non-codebook based PUSCH transmission, the first bit width is determined by

$$⌈ {log}_{2} ( {\sum }_{k = 1}^{min ( {L}_{max} , {N}_{m , SRS} )} ( \begin{matrix}{N}_{m , SRS} \\ k\end{matrix} ) ) ⌉ ,$$

and the second bit width is determined by a maximum number of codepoint(s) among all ranks associated with the first SRI field in a column corresponding to N_{m,SRS} of a non-codebook SRI indication table corresponding to Lₘₐₓ, wherein Lₘₐₓ is a maximum rank of the PUSCH transmission configured to the UE.

In some embodiments of the present application, in the case that the PUSCH mode field indicates that the PUSCH transmission is transmitted according to both the first SRS resource set and the second SRS resource set, the first SRI field is associated with the first SRS resource set and the second SRI field is associated with the second SRS resource set.

In some embodiments of the present application, the PUSCH mode field being “10” indicates that the PUSCH transmission is first based on the SRS resource(s) in the first SRS resource set and then based on the SRS resource(s) in the second SRS resource set, and the PUSCH mode field being “11” indicates that the PUSCH transmission is first based on the SRS resource(s) in the second SRS resource set and then based on the SRS resource(s) in the first SRS resource set.

In some embodiments of the present application, the second bit width is determined based on a number of SRS resource(s) in the second SRS resource set, N_{2,SRS}.

In some embodiments of the present application, in the case that the PUSCH transmission is a codebook based PUSCH transmission, the first bit width is determined by ┌log₂(N_{m,SRS})┐, and the second bit width is determined by ┌log₂(N_{2,SRS})┐.

In some embodiments of the present application, in the case that the PUSCH transmission is a non-codebook based PUSCH transmission, the first bit width is determined by

$$⌈ {log}_{2} ( {\sum }_{k = 1}^{min ( {L}_{max} , {N}_{m , SRS} )} ( \begin{matrix}{N}_{m , SRS} \\ k\end{matrix} ) ) ⌉ ,$$

and the second bit width is determined by a maximum number of codepoint(s) among all ranks associated with the first SRI field in a column corresponding to N_{2,SRS} of a non-codebook SRI indication table corresponding to Lₘₐₓ, wherein Lₘₐₓ is a maximum rank of the PUSCH transmission configured to the UE.

According to some other embodiments of the present application, a method performed by a UE may include: receiving configuration information of a first SRS resource set and a second SRS resource set for a PUSCH transmission, wherein each of the first SRS resource set and the second SRS resource set includes at least one SRS resource; determining that a first bit width of an SRI field associated with one SRS resource set of the first SRS resource set and the second SRS resource set is no less than 1 bit, and a second bit width of an SRI field associated with the other SRS resource set of the first SRS resource set and the second SRS resource set is 0 bit; and determining a bit width of each OLPC field of at least one OLPC field in DCI when a first p0-PUSCH-SetList associated with the one SRS resource set and a second p0-PUSCH-SetList associated with the other SRS resource set are configured to the UE.

In some embodiments of the present application, the DCI includes only one OLPC field.

In some embodiments of the present application, the bit width of the OLPC field is 1 bit.

In some embodiments of the present application, the OLPC field being “0” indicates that: (1) an OLPC parameter for a PUSCH transmission according to the one SRS resource set is determined from an SRI-PUSCH-PowerControl corresponding to the one SRS resource set with an sri-PUSCH-PowerControlld value mapped to a value of the SRI field with no less than 1 bit; and/or (2) an OLPC parameter for a PUSCH transmission according to the other SRS resource set is determined by a first P0-PUSCH-AlphaSet in p0-AlphaSets corresponding to the other SRS resource set; and the OLPC field being “1” indicates that: (1) an OLPC parameter for a PUSCH transmission according to the one SRS resource set is determined by a first value in a P0-PUSCH-Set with a p0-PUSCH-SetId value mapped to the value of the SRI field with no less than 1 bit in the first p0-PUSCH-SetList; and/or (2) an OLPC parameter for a PUSCH transmission according to the other SRS resource set is determined by a first value in a P0-PUSCH-Set with the lowest p0-PUSCH-SetId value in the second p0-PUSCH-SetList.

In some embodiments of the present application, the bit width of the OLPC field is 2 bits.

In some embodiments of the present application, the OLPC field being “00” indicates that: (1) an OLPC parameter for a PUSCH transmission according to the one SRS resource set is determined from an SRI-PUSCH-PowerControl corresponding to the one SRS resource set with an sri-PUSCH-PowerControlld value mapped to a value of the SRI field with no less than 1 bit; and/or (2) an OLPC parameter for a PUSCH transmission according to the other SRS resource set is determined by a first P0-PUSCH-AlphaSet in p0-AlphaSets corresponding to the other SRS resource set; the OLPC field being “01” indicates that: (1) an OLPC parameter for a PUSCH transmission according to the one SRS resource set is determined by a first value in a P0-PUSCH-Set with a p0-PUSCH-SetId value mapped to the value of the SRI field with no less than 1 bit in the first p0-PUSCH-SetList; and/or (2) an OLPC parameter for a PUSCH transmission according to the other SRS resource set is determined by a first value in a P0-PUSCH-Set with the lowest p0-PUSCH-SetId value in the second p0-PUSCH-SetList; and the OLPC field being “10” indicates that: (1) an OLPC parameter for a PUSCH transmission according to the one SRS resource set is determined by a second value in the P0-PUSCH-Set with the p0-PUSCH-SetId value mapped to the value of the SRI field with no less than 1 bit in the first p0-PUSCH-SetList; and/or (2) an OLPC parameter for a PUSCH transmission according to the other SRS resource set is determined by a second value in the P0-PUSCH-Set with the lowest p0-PUSCH-SetId value in the second p0-PUSCH-SetList.

In some embodiments of the present application, the DCI includes an OLPC field associated with the one SRS resource set and an OLPC field associated with the other SRS resource set.

In some embodiments of the present application, a bit width of the OLPC field associated with the one SRS resource set is 1 bit, and a bit width of the OLPC field associated with the other SRS resource set is 1 bit or 2 bits.

In some embodiments of the present application, the bit width of the OLPC field is indicated by a high layer parameter.

In some embodiments of the present application, the bit width of the OLPC field is determined by the first SRS resource set or the second SRS resource set which is determined by a pre-defined rule.

According to some embodiments of the present application, a method may include: transmitting configuration information of a first SRS resource set and a second SRS resource set for a PUSCH transmission, wherein each of the first SRS resource set and the second SRS resource set includes at least one SRS resource; and determining a first bit width of a first SRI field and a second bit width of a second SRI field in DCI, wherein the first bit width is determined based on a maximum number of SRS resource(s) configured in the first SRS resource set and the second SRS resource set, N_{m,SRS}.

In some embodiments of the present application, the method may further includes: transmitting a PUSCH mode field in the DCI indicating whether the PUSCH transmission is transmitted according to the first SRS resource set, the second SRS resource set, or both the first SRS resource set and the second SRS resource set.

In some embodiments of the present application, the second bit width is determined based on N_{m,SRS}.

In some embodiments of the present application, in the case that the PUSCH transmission is a codebook based PUSCH transmission, the first bit width and the second bit width are determined by ┌log₂(N_{m,SRS})┐.

In some embodiments of the present application, in the case that the PUSCH transmission is a non-codebook based PUSCH transmission, the first bit width is determined by

$$⌈ {log}_{2} ( {\sum }_{k = 1}^{min ( {L}_{max} , {N}_{m , SRS} )} ( \begin{matrix}{N}_{m , SRS} \\ k\end{matrix} ) ) ⌉ ,$$

and the second bit width is determined by a maximum number of codepoint(s) among all ranks associated with the first SRI field in a column corresponding to N_{m,SRS} of a non-codebook SRI indication table corresponding to Lₘₐₓ, wherein Lₘₐₓ is a maximum rank of the PUSCH transmission configured to a UE.

In some embodiments of the present application, in the case that the PUSCH mode field indicates that the PUSCH transmission is transmitted according to both the first SRS resource set and the second SRS resource set, the first SRI field is associated with the first SRS resource set and the second SRI field is associated with the second SRS resource set.

In some embodiments of the present application, the PUSCH mode field being “10” indicates that the PUSCH transmission is first based on the SRS resource(s) in the first SRS resource set and then based on the SRS resource(s) in the second SRS resource set, and the PUSCH mode field being “11” indicates that the PUSCH transmission is first based on the SRS resource(s) in the second SRS resource set and then based on the SRS resource(s) in the first SRS resource set.

In some embodiments of the present application, the second bit width is determined based on a number of SRS resource(s) in the second SRS resource set, N_{2,SRS}.

In some embodiments of the present application, in the case that the PUSCH transmission is a codebook based PUSCH transmission, the first bit width is determined by ┌log₂(N_{m,SRS})┐, and the second bit width is determined by ┌log₂(N_{2,SRS})┐.

In some embodiments of the present application, in the case that the PUSCH transmission is a non-codebook based PUSCH transmission, the first bit width is determined by

$$⌈ {log}_{2} ( {\sum }_{k = 1}^{min ( {L}_{max} , {N}_{m , SRS} )} ( \begin{matrix}{N}_{m , SRS} \\ k\end{matrix} ) ) ⌉ ,$$

and the second bit width is determined by a maximum number of codepoint(s) among all ranks associated with the first SRI field in a column corresponding to N_{2,SRS} of a non-codebook SRI indication table corresponding to Lₘₐₓ, wherein Lₘₐₓ is a maximum rank of the PUSCH transmission configured to a UE.

According to some other embodiments of the present application, a method may include: transmitting configuration information of a first SRS resource set and a second SRS resource set for a PUSCH transmission, wherein each of the first SRS resource set and the second SRS resource set includes at least one SRS resource; determining that a first bit width of an SRI field associated with one SRS resource set of the first SRS resource set and the second SRS resource set is no less than 1 bit, and a second bit width of an SRI field associated with the other SRS resource set of the first SRS resource set and the second SRS resource set is 0 bit; and determining a bit width of each OLPC field of at least one OLPC field in DCI when a first p0-PUSCH-SetList associated with the one SRS resource set and a second p0-PUSCH-SetList associated with the other SRS resource set are configured to a UE.

In some embodiments of the present application, the DCI includes only one OLPC field.

In some embodiments of the present application, the bit width of the OLPC field is 1 bit.

In some embodiments of the present application, the OLPC field being “0” indicates that: (1) an OLPC parameter for a PUSCH transmission according to the one SRS resource set is determined from an SRI-PUSCH-PowerControl corresponding to the one SRS resource set with an sri-PUSCH-PowerControlld value mapped to a value of the SRI field with no less than 1 bit; and/or (2) an OLPC parameter for a PUSCH transmission according to the other SRS resource set is determined by a first P0-PUSCH-AlphaSet in p0-AlphaSets corresponding to the other SRS resource set; and the OLPC field being “1” indicates that: (1) an OLPC parameter for a PUSCH transmission according to the one SRS resource set is determined by a first value in a P0-PUSCH-Set with a p0-PUSCH-SetId value mapped to the value of the SRI field with no less than 1 bit in the first p0-PUSCH-SetList, and/or (2) an OLPC parameter for a PUSCH transmission according to the other SRS resource set is determined by a first value in a P0-PUSCH-Set with the lowest p0-PUSCH-SetId value in the second p0-PUSCH-SetList.

In some embodiments of the present application, the bit width of the OLPC field is 2 bits.

In some embodiments of the present application, the OLPC field being “00” indicates that: (1) an OLPC parameter for a PUSCH transmission according to the one SRS resource set is determined from an SRI-PUSCH-PowerControl corresponding to the one SRS resource set with an sri-PUSCH-PowerControlld value mapped to a value of the SRI field with no less than 1 bit; and/or (2) an OLPC parameter for a PUSCH transmission according to the other SRS resource set is determined by a first P0-PUSCH-AlphaSet in p0-AlphaSets corresponding to the other SRS resource set; the OLPC field being “01” indicates that: (1) an OLPC parameter for a PUSCH transmission according to the one SRS resource set is determined by a first value in a P0-PUSCH-Set with a p0-PUSCH-SetId value mapped to the value of the SRI field with no less than 1 bit in the first p0-PUSCH-SetList; and/or (2) an OLPC parameter for a PUSCH transmission according to the other SRS resource set is determined by a first value in a P0-PUSCH-Set with the lowest p0-PUSCH-SetId value in the second p0-PUSCH-SetList; and the OLPC field being “10” indicates that: (1) an OLPC parameter for a PUSCH transmission according to the one SRS resource set is determined by a second value in the P0-PUSCH-Set with the p0-PUSCH-SetId value mapped to the value of the SRI field with no less than 1 bit in the first p0-PUSCH-SetList; and/or (2) an OLPC parameter for a PUSCH transmission according to the other SRS resource set is determined by a second value in the P0-PUSCH-Set with the lowest p0-PUSCH-SetId value in the second p0-PUSCH-SetList.

In some embodiments of the present application, the DCI includes an OLPC field associated with the one SRS resource set and an OLPC field associated with the other SRS resource set.

In some embodiments of the present application, a bit width of the OLPC field associated with the one SRS resource set is 1 bit, and a bit width of the OLPC field associated with the other SRS resource set is 1 bit or 2 bits.

In some embodiments of the present application, the bit width of the OLPC field is indicated by a high layer parameter.

In some embodiments of the present application, the bit width of the OLPC field is determined by the first SRS resource set or the second SRS resource set which is determined by a pre-defined rule.

Some embodiments of the present application also provide an apparatus, including: at least one non-transitory computer-readable medium having computer executable instructions stored therein; at least one receiving circuitry; at least one transmitting circuitry; and at least one processor coupled to the at least one non-transitory computer-readable medium, the at least one receiving circuitry and the at least one transmitting circuitry. The computer executable instructions are programmed to implement any method as described in the present application with the at least one receiving circuitry, the at least one transmitting circuitry and the at least one processor.

Embodiments of the present application provide a technical solution for M-TRP PUSCH repetition transmission, which provides several methods to determine the bit widths of SRI field(s) and OLPC field(s) in DCI format 0_1 or DCI format 0_2 when different SRS resource sets contain different numbers of SRS resource(s), thereby reducing the overhead in the DCI as well as considering the dynamic switching between the S-TRP and M-TRP based PUSCH transmission.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 is a schematic diagram illustrating an exemplary wireless communication system according to some embodiments of the present application;

FIG. 2 illustrates a flow chart of an exemplary method for M-TRP based PUSCH transmission according to some embodiments of the present application;

FIG. 3 illustrates exemplary PUSCH transmissions towards multiple TRPs based on different values of a PUSCH mode field according to some embodiments of the present application;

FIG. 4 illustrates a flow chart of an exemplary method for M-TRP based PUSCH transmission according to some embodiments of the present application; and

FIG. 5 illustrates a simplified block diagram of an exemplary apparatus for M-TRP based transmission according to some embodiments of the present application.

### DETAILED DESCRIPTION

The detailed description of the appended drawings is intended as a description of the preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as the 3rd generation partnership project (3GPP) 5G (NR), 3GPP long-term evolution (LTE) Release 8, and so on. It is contemplated that along with the developments of network architectures and new service scenarios, all embodiments in the present application are also applicable to similar technical problems; and moreover, the terminologies recited in the present application may change, which should not affect the principle of the present application.

A wireless communication system generally includes one or more base stations (BSs) and one or more UEs. Furthermore, a BS may be configured with one TRP (or panel) or more TRPs (or panels). A TRP can act like a small BS. The TRPs can communicate with each other by a backhaul link. Such backhaul link may be an ideal backhaul link or a non-ideal backhaul link. Latency of the ideal backhaul link may be deemed as zero, and latency of the non-ideal backhaul link may be tens of milliseconds and much larger, e.g. on the order of tens of milliseconds, than that of the ideal backhaul link.

In a wireless communication system, one single TRP can be used to serve one or more UEs under control of a BS. In different scenarios, TRP may be called in different terms. Persons skilled in the art should understand that as the 3GPP and the communication technology develop, the terminologies recited in the specification may change, which should not affect the scope of the present application. It should be understood that the TRP(s) (or panel(s)) configured for the BS may be transparent to a UE.

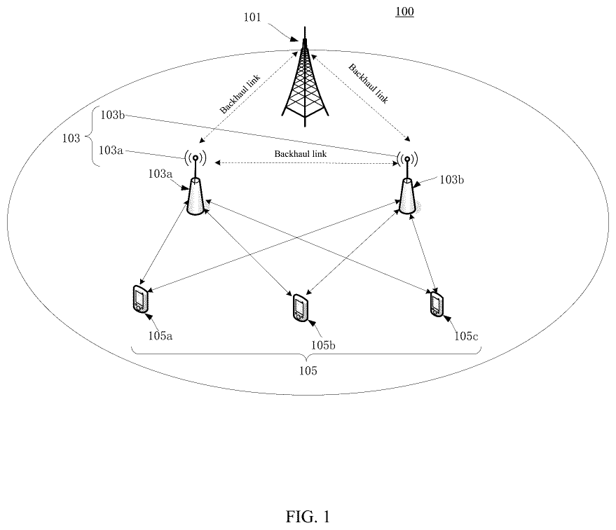

FIG. 1 is a schematic diagram illustrating an exemplary wireless communication system 100 according to some embodiments of the present application.

Referring to FIG. 1, the wireless communication system 100 can include a BS 101, TRPs 103 (e.g., TRP 103a and TRP 103b), and UEs 105 (e.g., UE 105a, UE 105b, and UE 105c). Although only one BS 101, two TRPs 103 and three UEs 105 are shown for simplicity, it should be noted that the wireless communication system 100 may include more or less communication device(s), apparatus, or node(s) in accordance with some other embodiments of the present application.

In some embodiments of the present application, the BS 101 may be referred to as an access point, an access terminal, a base, a base unit, a macro cell, a Node-B, an evolved Node B (eNB), a gNB, an ng-eNB, a Home Node-B, a relay node, or a device, or described using other terminology used in the art. The UEs 105 (for example, the UE 105a, the UE 105b, and the UE 105c) may include, for example, but is not limited to, a computing device, a wearable device, a mobile device, an internet of things (IoT) device, a vehicle, etc.

The TRPs 103, for example, the TRP 103a and the TRP 103b, can communicate with the BS 101 via, for example, a backhaul link. Each of TRPs 103 can serve some or all of the UEs 105. As shown in FIG. 1, the TRP 103a can serve some mobile stations (which include the UE 105a, the UE 105b, and the UE 105c) within a serving area or region (e.g., a cell or a cell sector). The TRP 103b can serve some mobile stations (which include the UE 105a, the UE 105b, and the UE 105c) within a serving area or region (e.g., a cell or a cell sector). The TRP 103a and the TRP 103b can communicate with each other via, for example, a backhaul link.

In Rel-17, PUSCH transmission to M-TRP is specified to improve reliability and robustness wherein each PUSCH transmission to a TRP carries a same transport block (TB). In RAN1 #103e meeting, two SRS resource sets used for codebook (CB) or non-codebook (nCB) based PUSCH transmission may be configured for a UE in a bandwidth part (BWP) to support M-TRP PUSCH repetition transmission, wherein one SRS resource set is used for at least one PUSCH transmission towards a TRP, and the other SRS resource set is used for at least one PUSCH transmission towards another TRP. The numbers of SRS resources in the two SRS resource sets may be different when different panels are equipped by the UE. In RAN1 #105e meeting, it has been agreed to support dynamically switching between S-TRP based PUSCH transmission and M-TRP based PUSCH transmission.

When two SRS resource sets for CB or nCB based PUSCH transmission are configured, two SRI fields and two transmission precoding matrix indicator (TPMI) fields (e.g. precoding information and number of layers fields as specified in 3GPP standard documents) may be contained in DCI format 0_1 or DCI format 0_2. An SRI field may be used to indicate the SRS resource(s) in a SRS resource set used for the PUSCH transmission. In addition, for a non-codebook based PUSCH transmission, the first SRI field may also indicate the number of layers of the PUSCH transmission to both TRPs. The TPMI fields are for CB based PUSCH transmission only, wherein a TPMI field is used for indicating a precoding matrix index from a pre-defined codebook to a UE based on the SRS resource in the configured SRS resource set indicated by an SRI field in DCI. For the S-TRP based PUSCH transmission, the first SRI field and first TPMI field (for CB based PUSCH transmission only) are used to determine the SRS resource(s) and the precoding matrix for PUSCH transmission. For the M-TRP PUSCH repetition transmission, the correspondence between the SRS resource sets and the SRI fields has not been determined yet.

In Rel-15 or Rel-16, for the S-TRP based PUSCH transmission, a single SRS resource set may be configured for a CB or nCB based PUSCH transmission to a UE, and the bit width of the single SRI field is determined based on the number of SRS resource(s) within the single SRS resource set.

However, as stated above, in Rel-17, two SRS resource sets may be configured for a UE and two SRI fields may be used. An SRI field may correspond to a first SRS resource set or may correspond to a second SRS resource set. When different numbers of SRS resource(s) are configured for the two SRS resource sets, how to determine the bit width of each SRI field by considering the dynamic switching between S-TRP based PUSCH transmission and M-TRP based PUSCH transmission is needed to be addressed.

In addition, in Rel-16, an OLPC parameter for a PUSCH transmission can be indicated by an OLPC filed in DCI format 0_1 or format 0_2, and the bit width of the OLPC field depends on whether an SRI field is present in the DCI when a P0 list (e.g., p0-PUSCH-SetList-r16 as specified in 3GPP standard documents) introduced in Rel-16 is configured. However, in Rel-17, when two SRS resource sets are configured but only one SRI field is valid (or present) in the DCI, how to determine the bit width of an OLPC filed is also needed to be addressed.

Given the above, embodiments of the present application aim to provide solutions for M-TRP PUSCH repetition transmission. Accordingly, embodiments of the present application provide several methods to determine the bit width of SRI field(s) and OLPC field(s) in DCI format 0_1 or format 0_2 when different SRS resource sets contain different numbers of SRS resource(s), thereby reducing the overhead in DCI as well as considering the dynamic switching between the S-TRP based and M-TRP based PUSCH transmissions. More details on embodiments of the present application will be described in the following text in combination with the appended drawings.

FIG. 2 illustrates a flow chart of an exemplary method for M-TRP based PUSCH transmission according to some embodiments of the present application. Although the method is illustrated in a system level by a UE and a BS (e.g., UE 105 and BS 101 as illustrated and shown in FIG. 1), persons skilled in the art can understand that the method implemented in the UE and that implemented in the BS can be separately implemented and incorporated by other apparatus with the like functions.

As shown in FIG. 2, in step 201, the BS may transmit configuration information of a first SRS resource set and a second SRS resource set for a codebook or a non-codebook based PUSCH transmission to the UE. The first SRS resource set may refer to the SRS resource set with a lower index or identifier (ID) (e.g., SRS-ResourceId as specified in 3GPP standard documents), and the second SRS resource set may refer to the SRS resource set with a higher index or ID. The first SRS resource set may be used for at least one PUSCH transmission towards a first TRP (e.g., TRP #1), and the second SRS resource set may be used for at least one PUSCH transmission towards a second TRP (e.g., TRP #2). Each of the first SRS resource set and the second SRS resource set may include at least one SRS resource.

Consequently, in step 202, the UE may receive the configuration information of the first SRS resource set and the second SRS resource set from the BS.

After receiving the configuration information, in step 204, the UE may determine a first bit width of a first SRI field and a second bit width of a second SRI field in DCI. The DCI may be DCI format 0_1 or DCI format 0_2 as specified in the 3GPP standard documents.

The BS also needs to determine the first bit width and the second bit width. That is, after transmitting the configuration information, in step 203, the BS may determine the first bit width of the first SRI field and the second bit width of the second SRI field in the DCI. The BS may use the same method as that used by the UE to determine the first bit width and the second bit width, which will be described below. The DCI may be DCI format 0_1 or DCI format 0_2 as specified in the 3GPP standard documents. Step 204 and step 203 can be performed independently at the UE and the BS, respectively.

The correspondence between the two SRS resource sets (i.e., the first SRS resource set and a second resource set) and the two SRI fields (i.e., the first SRI field and the second SRI field) may be determined based on a PUSCH mode field in the DCI. Accordingly, in some embodiments of the present application, the BS may transmit a PUSCH mode field in the DCI to the UE, and the PUSCH mode field may indicate whether the PUSCH transmission is transmitted according to the first SRS resource set, the second SRS resource set, or both the first SRS resource set and the second SRS resource set. Consequently, the UE may receive the PUSCH mode field in the DCI. In an embodiment of the present application, the PUSCH mode field may be a 2-bit field in the DCI.

For example, the following Table 1 provides an example of codepoints of a 2-bit PUSCH mode field.

TABLE 1
codepoints of a 2-bit PUSCH mode field

| PUSCH | | |
|---|---|---|
| mode | | SRI (for both CB and nCB)/ |
| Codepoint | SRS resource set(s) | TPMI (CB only) field(s) |
| 00 | S-TRP mode with first SRS | first SRI/TPMI field |
| | resource set (TRP #1) | (second SRI/TPMI field |
| | | is unused) |
| 01 | S-TRP mode with second | first SRI/TPMI field |
| | SRS resource set (TRP #2) | (second SRI/TPMI field |
| | | is unused) |
| 10 | M-TRP mode with (TRP | both first and second |
| | #1, TRP #2 order); | SRI/TPMI fields |
| | first SRI/TPMI field: | |
| | first SRS resource set; | |
| | second SRI/TPMI field: | |
| | second SRS resource set | |
| 11 | M-TRP mode with (TRP | both first and second |
| | #2, TRP #1 order); | SRI/TPMI fields |
| | first SRI/TPMI field: | |
| | not determined; | |
| | second SRI/TPMI field: | |
| | not determined | |

Referring to Table 1, the PUSCH mode field being “00” means that:
The PUSCH transmission is an S-TRP based PUSCH transmission.
The PUSCH transmission is transmitted according to the SRS resource(s) in the first SRS resource set. That is, the PUSCH transmission is towards the first TRP (i.e., TRP #1).
The first SRI field is used to indicate the SRS resource(s) in the first SRS resource set used for the PUSCH transmission, while the second SRI field is not used and can be ignored by the UE. That is, the first SRI field is associated with the first SRS resource set. Also, the first TPMI field is used if the PUSCH transmission is a codebook based PUSCH transmission and is associated with the first SRS resource set, while the second TPMI field is not used and can be ignored by the UE.

The PUSCH mode field being “01” means that:
The PUSCH transmission is an S-TRP based PUSCH transmission.
The PUSCH transmission is transmitted according to the SRS resource(s) in the second SRS resource set. That is, the PUSCH transmission is towards the second TRP (i.e., TRP #2).
The first SRI field is used to indicate the SRS resource(s) in the second SRS resource set used for the PUSCH transmission, while the second SRI field is not used and can be ignored by the UE. That is, the first SRI field is associated with the second SRS resource set. Also, the first TPMI field is used if the PUSCH transmission is a codebook based PUSCH transmission and is associated with the second SRS resource set, while the second TPMI field is not used and can be ignored by the UE.

The PUSCH mode field being “10” means that:
The PUSCH transmission is an M-TRP based PUSCH transmission.
The PUSCH transmission is transmitted according to the SRS resources in the first SRS resource set and the second SRS resource set. That is, the PUSCH transmission is towards both the first TRP (i.e., TRP #1) and the second TRP (i.e., TRP #2).
Both the first SRI field and the second SRI field are used. The first SRI field is used to indicate the SRS resource(s) in the first SRS resource set used for the PUSCH transmission to TRP #1, and the second SRI field is used to indicate the SRS resource(s) in the second SRS resource set used for the PUSCH transmission to TRP #2. That is, the first SRI field is associated with the first SRS resource set and the second SRI field is associated with the second SRS resource set. Also, both the first TPMI field and the second TPMI field are used if the PUSCH transmission is a codebook based PUSCH transmission, the first TPMI field is associated with the first SRS resource set and the second TPMI field is associated with the second SRS resource set.
The PUSCH transmission is first towards TRP #1 and then towards TRP #2. That is, the PUSCH transmission is first based on the SRS resource(s) in the first SRS resource set and then based on the SRS resource(s) in the second SRS resource set. In the case that the PUSCH transmission is a codebook based PUSCH transmission, the SRS resource(s) in the first SRS resource set is indicated by the first SRI field and the SRS resource(s) in the second SRS resource set is indicated by the second SRI field. In the case that the PUSCH transmission is a non-codebook based PUSCH transmission, the SRS resource(s) in the first SRS resource set is indicated by the first SRI field, and the SRS resource(s) in the second SRS resource set is indicated by a combination of the first SRI field and the second SRI field. For example, the first SRI field may be used to indicate the rank (i.e., the number of layers) for the non-codebook based PUSCH transmission, and the second SRI field may be used to indicate the SRS resource(s) in the second SRS resource set corresponding to the rank indicated by the first SRI field.

The PUSCH mode field being “11” means that:
The PUSCH transmission is an M-TRP based PUSCH transmission.
The PUSCH transmission is transmitted according to the SRS resources in both the first SRS resource set and the second SRS resource set. That is, the PUSCH transmission is towards both the first TRP (i.e., TRP #1) and the second TRP (i.e., TRP #2).
Both the first SRI field and the second SRI field are used. However, the correspondence between the two SRS resource sets (i.e., the first SRS resource set and a second resource set) and the two SRI fields (i.e., the first SRI field and the second SRI field) has not been determined yet. Accordingly, there are two possible correspondences. One is that the first SRI field is used to indicate the SRS resource(s) in the first SRS resource set used for the PUSCH transmission, and the second SRI field is used to indicate the SRS resource(s) in the second SRS resource set used for the PUSCH transmission (i.e., the first SRI field is associated with the first SRS resource set and the second SRI field is associated with the second SRS resource set). The other one is that the first SRI field is used to indicate the SRS resource(s) in the second SRS resource set used for the PUSCH transmission, and the second SRI field is used to indicate the SRS resource(s) in the first SRS resource set used for the PUSCH transmission (i.e., the first SRI field is associated with the second SRS resource set and the second SRI field is associated with the first SRS resource set). Also, both the first TPMI field and the second TPMI field are used if the PUSCH transmission is a codebook based PUSCH transmission, but the correspondence between the two SRS resource sets (i.e., the first SRS resource set and a second resource set) and the two TPMI fields (i.e., the first TPMI field and the second TPMI field) has not been determined yet.
The PUSCH transmission is first towards TRP #2 and then towards TRP #1. That is, the PUSCH transmission is first based on the SRS resource(s) in the second SRS resource set and then based on the SRS resource(s) in the first SRS resource set.

Consequently, considering both S-TRP and M-TRP based PUSCH transmissions in Table 1, the first SRI field may be associated with either the first SRS resource set or the second SRS resource set, which depends on the PUSCH mode field. Thus, the BS and the UE may determine the first bit width of the first SRI field based on a maximum number of SRS resource(s) configured in the first SRS resource set and the second SRS resource set, N_{m,SRS}. That is, N_{m,SRS}=max(N_{1,SRS}, N_{2,SRS}), wherein N_{1,SRS} is the number of SRS resource(s) in the first SRS resource set and N_{2,SRS} is the number of SRS resource(s) in the second SRS resource set.

Likewise, the second SRI field may also be associated with either the first SRS resource set or the second SRS resource set, which depends on the PUSCH mode field. Thus, the BS and the UE may also determine the second bit width of the second SRI field based on the maximum number of SRS resource(s) configured in the first SRS resource set and the second SRS resource set, N_{m,SRS}.

The valid codepoint(s) of each SRI field of the first SRI field and the second SRI field is (are) determined by the actual number of SRS resource(s) configured in the SRS resource set associated with the SRI field, which depends on the PUSCH mode field. Remaining codepoint(s), if any, of the first SRI field and the second SRI field can be reserved.

In some embodiments of the present application, the PUSCH transmission may be a CB based PUSCH transmission. In such embodiments, the first bit width and the second bit width are determined by ┌log₂(N_{m,SRS})┐.

For example, it is assumed that a DCI format 0_1 schedules a CB based PUSCH transmission towards TRP #1 and TRP #2. Two SRS resource sets are configured for a UE for the CB based PUSCH transmission, and the first SRS resource set contains one SRS resource for PUSCH transmission to TRP #1 and the second SRS resource set contains two SRS resources for PUSCH transmission to TRP #2. Then both the first bit width of the first SRI field and the second bit width of the second SRI field are ┌log₂(N_{m,SRS})┐=┌log 2(2)┐=1 bit.

When the PUSCH mode field is “00”, the first SRI field may be 1 bit to indicate the SRS resource in the first SRS resource set used for the PUSCH transmission to TRP #1. Although the second SRI field is not used in this case, it is also 1 bit. Since there is only one SRS resource in the first SRS resource set, one state of the first SRI field (e.g., the first SRI field being “0” or the first SRI field being “1”) can be used for indicating the SRS resource in the first SRS resource set and the other state can be reserved.

When the PUSCH mode field is “01”, the first SRI field may be 1 bit to indicate the SRS resource(s) in the second SRS resource set used for the PUSCH transmission to TRP #2. Although the second SRI field is not used in this case, it is also 1 bit. Since there are two SRS resources in the second SRS resource set, one state of the first SRI field (e.g., the first SRI field being “0” or the first SRI field being “1”) can be used for indicating one SRS resource in the second SRS resource set, and the other state of the first SRI field can be used for indicating the other SRS resource in the second SRS resource set.

When the PUSCH mode field is “10”, the first SRI field may be 1 bit to indicate the one SRS resource in the first SRS resource set used for the PUSCH transmission to TRP #1, and the second SRI field may be 1 bit to indicate the resource(s) in the second SRS resource set used for the PUSCH transmission to TRP #2. The similar indication method may be used in the case that the PUSCH mode field is “11” if the correspondence between the two SRI fields and the two SRS resource sets is specified.

In some other embodiments of the present application, the PUSCH transmission may be an nCB based PUSCH transmission. In such embodiments, the first bit width is determined by

$$⌈ {log}_{2} ( {\sum }_{k = 1}^{min ( {L}_{max} , {N}_{m , SRS} )} ( \begin{matrix}{N}_{m , SRS} \\ k\end{matrix} ) ) ⌉ ,$$

and the second bit width is determined by a maximum number of codepoint(s) among all ranks associated with the first SRI field (i.e. the value of rank may be indicated by the first SRI field) in a column corresponding to N_{m,SRS} of an nBC SRI indication table corresponding to Lₘₐₓ, wherein Lₘₐₓ is a maximum rank of the PUSCH transmission configured to the UE.

For example, it is assumed that a DCI format 0_1 schedules an nCB PUSCH transmission towards TRP #1 and TRP #2, and the maximum number of layers (i.e., the maximum rank) of PUSCH transmission configured to a UE is two (i.e., Lₘₐₓ=2). Two SRS resource sets are configured for the UE for the nCB based PUSCH transmission, and the first SRS resource set contains two SRS resources for the PUSCH transmission towards TRP #1 and the second SRS resource set contains four SRS resources for the PUSCH transmission towards TRP #2.

The following Table 2 is an nBC SRI indication table corresponding to Lₘₐₓ=2, which is based on table 7.3.1.1.2-29 in TS 38.212. Referring to Table 2, each SRI field may indicate at least one SRI for at least one SRS resource.

TABLE 2
SRI indication for nBC based PUSCH transmission, Lₘₐₓ = 2

| Bit field | | Bit field | | Bit field | |
|---|---|---|---|---|---|
| mapped | SRI(s), | mapped | SRI(s), | mapped | SRI(s), |
| to index | N_{SRS} = 2 | to index | N_{SRS} = 3 | to index | N_{SRS} = 4 |
| 0 | 0 | 0 | 0 | 0 | 0 |
| 1 | 1 | 1 | 1 | 1 | 1 |
| 2 | 0, 1 | 2 | 2 | 2 | 2 |
| 3-15 | Reserved | 3 | 0, 1 | 3 | 3 |
| | | 4 | 0, 2 | 4 | 0, 1 |
| | | 5 | 1, 2 | 5 | 0, 2 |
| | | 6-15 | Reserved | 6 | 0, 3 |
| | | | | 7 | 1, 2 |
| | | | | 8 | 1, 3 |
| | | | | 9 | 2, 3 |
| | | | | 10-15 | reserved |

The first bit width of the first SRI field may be determined as

$$⌈ {log}_{2} ( {\sum }_{k = 1}^{min ( {L}_{max} , {N}_{m , SRS} )} ( \begin{matrix}{N}_{m , SRS} \\ k\end{matrix} ) ) ⌉ = ⌈ {log}_{2} ( {\sum }_{k = 1}^{min ( 2 , 4 )} ( \begin{matrix}4 \\ k\end{matrix} ) ) ⌉ = 4 bits .$$

The second bit width of the second SRI field may be determined by a maximum number of codepoint(s) among all ranks associated with the first SRI field in a column corresponding to N_{SRS}=N_{m,SRS}=4 in Table 2 (i.e., the fifth column from the left in Table 2). The ranks associated with the first SRI field are rank 1 and rank 2 in this case. Referring to the fifth and sixth columns, the number of codepoint(s) for rank 1 is 4 (i.e., codepoints 0, 1, 2, and 3) and the number of codepoint(s) for rank 2 is 6 (i.e., codepoints 4-9). That is, the maximum number of codepoint(s) among all ranks associated with the first SRI field is 6. Accordingly, the second bit width of the second SRI field is ┌log₂(6)┐=3 bits.

If the PUSCH mode field is “00”, the SRS resource(s) indicated in the first SRS resource set by the first SRI field will be used for the PUSCH transmission. Since there are two SRS resources in the first SRS resource set, the valid codepoints are the codepoints included in the first column from the left in Table 2 which corresponds to the number of SRS resource(s) configured in the associated first SRS resource set. Although the second SRI field is not used in this case, it is also 3 bits.

If the PUSCH mode field is “01”, the SRS resource(s) indicated in the second resource set by the first SRI field will be used for the PUSCH transmission. Since there are four SRS resources in the second SRS resource set, the valid codepoints are the codepoints in the fifth column from the left which corresponds to the number of SRS resource(s) configured in the associated second SRS resource set in Table 2. Although the second SRI field is not used in this case, it is also 3 bits.

If the PUSCH mode field is “10”, the first SRI field may be used to indicate one or more of the two SRS resources in the first SRS resource set and the second SRI field may be used to indicate one or more of the four SRS resources in the second SRS resource set. The valid codepoints of the first SRI field are the codepoints included in the first column from the left in Table 2, and the valid codepoints of the second SRI field are the codepoints included in the fifth column from the left in Table 2. The similar indication method may be used in the case that PUSCH mode field is “11” if the correspondence between the two SRI fields and the two SRS resource sets is specified, and the valid codepoints associated with each SRI field is determined by its associated SRS resource set as indicated by the PUSCH mode field being “11”.

According to some other embodiments of the present application, the following Table 3 provides another example of codepoints of a 2-bit PUSCH mode field.

TABLE 3
codepoints of a 2-bit PUSCH mode field

| PUSCH | | |
|---|---|---|
| mode | | SRI (for both CB and NCB)/ |
| Codepoint | SRS resource set(s) | TPMI (CB only) field(s) |
| 00 | S-TRP mode with first SRS | first SRI/TPMI field |
| | resource set (TRP #1) | (second SRI/TPMI field |
| | | is unused) |
| 01 | S-TRP mode with second | first SRI/TPMI field |
| | SRS resource set (TRP #2) | (second SRI/TPMI field |
| | | is unused) |
| 10 | M-TRP mode with (TRP | both first and second |
| | #1, TRP #2 order); | SRI/TPMI fields |
| | first SRI/TPMI field: | |
| | first SRS resource set; | |
| | second SRI/TPMI field: | |
| | second SRS resource set | |
| 11 | M-TRP mode with (TRP | both first and second |
| | #2, TRP #1 order); | SRI/TPMI fields |
| | first SRI/TPMI field: | |
| | first SRS resource set; | |
| | second SRI/TPMI field: | |
| | second SRS resource set | |

Referring to Table 3, the meanings of the PUSCH mode field being “00”, the PUSCH mode field being “01”, and the PUSCH mode field being “10” are the same as those in Table 1. The PUSCH mode field being “11” means that:
The PUSCH transmission is an M-TRP based PUSCH transmission.
The PUSCH transmission is transmitted according to the SRS resources in the first SRS resource set and the second SRS resource set. That is, the PUSCH transmission is towards both the first TRP (i.e., TRP #1) and the second TRP (i.e., TRP #2).
Both the first SRI field and the second SRI field are used. The first SRI field is used to indicate the SRS resource(s) in the first SRS resource set used for the PUSCH transmission to TRP #1, and the second SRI field is used to indicate the SRS resource(s) in the second SRS resource set used for the PUSCH transmission to TRP #2. That is, the first SRI field is associated with the first SRS resource set and the second SRI field is associated with the second SRS resource set. Also, both the first TPMI field and the second TPMI field are used if the PUSCH transmission is a codebook based PUSCH transmission, the first TPMI field is associated with the first SRS resource set and the second TPMI field is associated with the second SRS resource set.
The PUSCH transmission is first towards TRP #2 and then towards TRP #1. That is, the PUSCH transmission is transmitted first based on the SRS resource(s) in the second SRS resource set and then based on the SRS resource(s) in the first SRS resource set.

Referring to Table 3, when the PUSCH mode field being “10” or “11” (i.e., the PUSCH transmission is transmitted according to both the first SRS resource set and the second SRS resource set), the first SRI field is associated with the first SRS resource set, and the second SRI field is associated with the second SRS resource set. The difference between the PUSCH mode field being “10” and the PUSCH mode field being “11” is the application order of the first SRS resource set and the second SRS resource set. That is, the PUSCH mode field being “10” indicates that the PUSCH transmission is first based on the SRS resource(s) in the first SRS resource set and then based on the SRS resource(s) in the second SRS resource set, and the PUSCH mode field being “11” indicates that the PUSCH transmission is first based on the SRS resource(s) in the second SRS resource set and then based on the SRS resource(s) in the first SRS resource set.

In the case that the PUSCH transmission is a codebook based PUSCH transmission, the SRS resource(s) in the second SRS resource set is indicated by the second SRI field and the SRS resource(s) in the first SRS resource set is indicated by the first SRI field. In the case that the PUSCH transmission is a non-codebook based PUSCH transmission, the SRS resource(s) in the first SRS resource set is indicated by the first SRI field, and the SRS resource(s) in the second SRS resource set is indicated by a combination of the first SRI field and the second SRI field. For example, the first SRI field may be used to indicate the rank (i.e., the number of layers) for the non-codebook based PUSCH transmission, and the second SRI field may be used to indicate the SRS resource(s) in the second SRS resource set corresponding the rank indicated by the first SRI field. Taking Table 2 as an example, when N_{1,SRS}=N_{2,SRS}=4 and the first SRI field is “4” in the fifth column from the left, the rank for the non-codebook based PUSCH transmission is 2, and the second SRI field may be used to indicate the SRS resources (0,1), (0,2), (0,3), (1,2), (1,3), or (2,3) corresponding to rank 2 in the second SRS resource set.

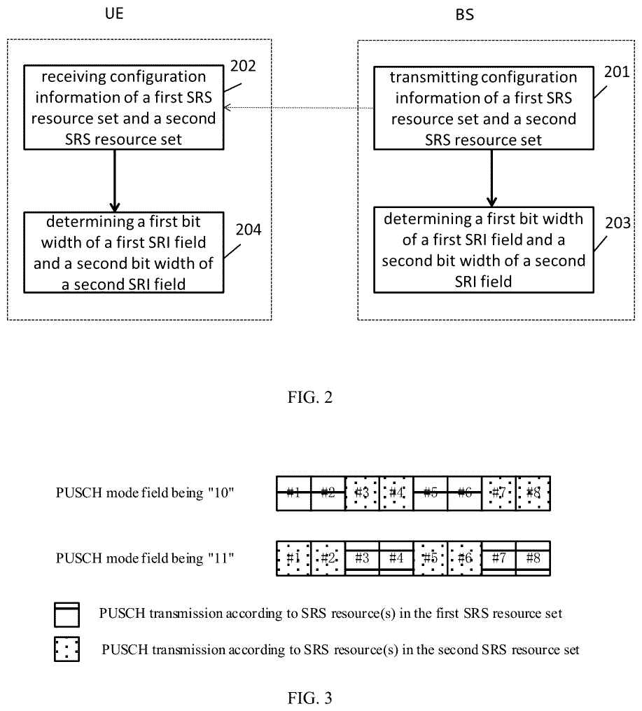

For example, FIG. 3 illustrates exemplary PUSCH transmissions towards multiple TRPs with different values of the PUSCH mode field according to some embodiments of the present application.

Referring to FIG. 3, it is assumed that the repetition number of the PUSCH transmission is 8 and the M-TRP based PUSCH transmission pattern is sequential. That is, two consecutive PUSCH transmissions towards a TRP followed by another two consecutive transmissions towards another TRP are transmitted until reaching the repetition number of the PUSCH transmission. Then the PUSCH transmissions for PUSCH mode field being “10” and “11” are illustrated in FIG. 3.

Referring to FIG. 3, the PUSCH mode field being “10” indicates that the first two PUSCH transmissions (i.e., PUSCH transmission #1 and PUSCH transmission #2) are based on the SRS resource(s) in the first SRS resource set, which is followed by two PUSCH transmissions (i.e., PUSCH transmission #3 and PUSCH transmission #4) based on the SRS resource(s) in the second SRS resource set. Such kind of sequence will be repeated until the 8 PUSCH transmissions are reached.

The PUSCH mode field being “11” indicates that the first two PUSCH transmissions (i.e., PUSCH transmission #1 and PUSCH transmission #2) are based on the SRS resource(s) in the second SRS resource set, which is followed by two PUSCH transmissions (i.e., PUSCH transmission #3 and PUSCH transmission #4) based on the SRS resource(s) in the first SRS resource set. Such kind of sequence will be repeated until the 8 PUSCH transmissions are reached.

Considering both S-TRP and M-TRP based PUSCH transmissions in Table 3, the first SRI field may be associated with either the first SRS resource set or the second SRS resource set, which depends on the PUSCH mode field. However, the second SRI field may either unused or always be associated with the second SRS resource set, which depends on the PUSCH mode field. Given this, the BS and the UE may determine the first bit width of the first SRI field based on a maximum number of SRS resource(s) configured in the first SRS resource set and the second SRS resource set, N_{m,SRS}, and determine the second bit width of the second SRI field based on a number of SRS resource(s) in the second SRS resource set, N_{2,SRS}. Compared with the method in which both the first bit width and the second bit width are determined based on N_{m,SRS}, this method may save some overhead in DCI when the second SRS resource set contains fewer SRS resources than the first SRS resource set.

In some embodiments of the present application, the PUSCH transmission may be a CB based PUSCH transmission. In such embodiments, the first bit width is determined by ┌log₂(N_{m,SRS})┐ and the second bit width is determined by ┌log₂(N_{2,SRS})┐.

For example, it is assumed that a DCI format 0_1 schedules a CB based PUSCH transmission towards TRP #1 and TRP #2. Two SRS resource sets are configured for a UE for the CB based PUSCH transmission, and the first SRS resource set contains four SRS resources for PUSCH transmission towards TRP #1 and the second SRS resource set contains two SRS resources for PUSCH transmission towards TRP #2. Then the first bit width of the first SRI field is ┌log₂(N_{m,SRS})┐=┌log 2(4)┐=2 bits, and the second bit width of the second SRI field is ┌log₂(N_{2,SRS})┐=┌log 2(2)┐=1 bit.

When the PUSCH mode field is “00”, the first SRI field may be 2 bits to indicate the SRS resource(s) in the first SRS resource set used for the PUSCH transmission to TRP #1. Although the second SRI field is not used in this case, it is also 1 bit. Since there are four SRS resources in the first SRS resource set, the four states of the first SRI field (e.g., the first SRI field being “00,” “01”, “10”, and “11”) are used for indicating the four SRS resources, respectively.

When the PUSCH mode field is “01”, the first SRI field may be 2 bits to indicate the SRS resource(s) in the second SRS resource set used for the PUSCH transmission to TRP #2. Although the second SRI field is not used in this case, it is also 1 bit. Since there are two SRS resources in the second SRS resource set, two states of the first SRI field may be used for indicating the two SRS resources in the second SRS resource set and the other two states of the first SRI field may be reserved.

When the PUSCH mode field is “10” or “11”, the first SRI field may be 2 bits to indicate the SRS resource(s) in the first SRS resource set used for the PUSCH transmission to TRP #1 and the second SRI field may be 1 bit to indicate the SRS resource(s) in the second SRS resource set used for the PUSCH transmission to TRP #2. The difference between the PUSCH mode field being “10” and the PUSCH mode field being “11” is the application order of the first SRS resource set and the second SRS resource set, which is illustrated in FIG. 3.

In some other embodiments of the present application, the PUSCH transmission may be an nCB based PUSCH transmission. In such embodiments, the first bit width is determined by

$$⌈ {log}_{2} ( {\sum }_{k = 1}^{min ( {L}_{max} , {N}_{m , SRS} )} ( \begin{matrix}{N}_{m , SRS} \\ k\end{matrix} ) ) ⌉ ,$$

and the second bit width is determined by a maximum number of codepoint(s) among all ranks associated with the first SRI field in a column corresponding to N_{2,SRS} of an nBC SRI indication table corresponding to Lₘₐₓ, wherein Lₘₐₓ is a maximum rank of the PUSCH transmission configured to the UE.

For example, it is assumed that a DCI format 0_1 schedules an nCB PUSCH transmission towards TRP #1 and TRP #2, and the maximum number of layers (i.e., the maximum rank) of PUSCH transmission configured to a UE is two (i.e., Lₘₐₓ=2). Two SRS resource sets are configured for the UE for the nCB based PUSCH transmission, and the first SRS resource set contains four SRS resources for PUSCH transmission towards TRP #1 and the second SRS resource set contains two SRS resources for PUSCH transmission towards TRP #2.

The following Table 4 is an nBC SRI indication table corresponding to Lₘₐₓ=2, which is the same as table 7.3.1.1.2-29 in TS 38.212. Referring to Table 4, each SRI field may indicate at least one SRI for at least one SRS resource.

TABLE 4
SRI indication for nBC based PUSCH transmission, Lₘₐₓ = 2

| Bit field | | Bit field | | Bit field | |
|---|---|---|---|---|---|
| mapped | SRI(s), | mapped | SRI(s), | mapped | SRI(s), |
| to index | N_{SRS} = 2 | to index | N_{SRS} = 3 | to index | N_{SRS} = 4 |
| 0 | 0 | 0 | 0 | 0 | 0 |
| 1 | 1 | 1 | 1 | 1 | 1 |
| 2 | 0, 1 | 2 | 2 | 2 | 2 |
| 3 | Reserved | 3 | 0, 1 | 3 | 3 |
| | | 4 | 0, 2 | 4 | 0, 1 |
| | | 5 | 1, 2 | 5 | 0, 2 |
| | | 6-7 | reserved | 6 | 0, 3 |
| | | | | 7 | 1, 2 |
| | | | | 8 | 1, 3 |
| | | | | 9 | 2, 3 |
| | | | | 10-15 | reserved |

The first bit width of the first SRI field may be determined as

$$⌈ {log}_{2} ( {\sum }_{k = 1}^{min ( {L}_{max} , {N}_{m , SRS} )} ( \begin{matrix}{N}_{m , SRS} \\ k\end{matrix} ) ) ⌉ = ⌈ {log}_{2} ( {\sum }_{k = 1}^{min ( 2 , 4 )} ( \begin{matrix}4 \\ k\end{matrix} ) ) ⌉ = 4 bits .$$

The second bit width of the second SRI field may be determined by a maximum number of codepoint(s) among all ranks associated with the first SRI field in a column corresponding to N_{SRS}=N_{2,SRS}=2 in Table 4 (i.e., the first column from the left in Table 4). The ranks associated with the first SRI field is rank 1 and rank 2 in this case. Referring to the first and second columns, the number of codepoint(s) for rank 1 is 2 (i.e., codepoints 0 and 1) and the number of codepoint(s) for rank 2 is 1 (i.e., codepoint 2). That is, the maximum number of codepoint(s) among all ranks associated with the first SRI field is 2. Accordingly, the second bit width of the second SRI field is ┌log 2(2)┐=1 bit.

If the PUSCH mode field is “00”, the SRS resource(s) indicated in the first SRS resource set by the first SRI field will be used for the PUSCH transmission. Since there are four SRS resources in the first SRS resource set, the valid codepoints are the codepoints in the fifth column from the left which corresponds to the number of SRS resource(s) configured in the associated first SRS resource set in Table 4. Although the second SRI field is not used in this case, it is also 1 bit.

If the PUSCH mode field is “01”, the SRS resource(s) indicated in the second resource set by the first SRI field will be used for the PUSCH transmission. Since there are two SRS resources in the second SRS resource set, the valid codepoints are the codepoints in the first column from the left which corresponds to the number of SRS resource(s) configured in the associated second SRS resource set in Table 4. Although the second SRI field is not used in this case, it is also 1 bit.

If the PUSCH mode field is “10” or “10”, the first SRI field may be used to indicate one or more of the four SRS resources in the first SRS resource set and the second SRI field may be used to indicate one or more of the two SRS resources in the second SRS resource set. The valid codepoints of the first SRI field are the codepoints in the fifth column from the left in Table 4, and the valid codepoints of the second SRI field are the codepoints in the first column from the left in Table 4. The difference between the PUSCH mode field being “10” and the PUSCH mode field being “11” is the application order of the first SRS resource set and the second SRS resource set, which is illustrated in FIG. 3.

In Rel-16, when a high layer parameter p0-PUSCH-SetList (e.g., p0-PUSCH-SetList-r16 as specified in 3GPP standard documents, which is a list of p0-PUSCH-Set-r16 for configuring the target receiving power at a BS) as specified in 3GPP standard documents is configured by a BS to a UE, the bit width of an OLPC field in DCI format 0_1 or DCI format 0_2 may be 1 or up to 2 bits, which is based on whether an SRI field is present in the DCI or not. For example, when the SRI field is present in the DCI (i.e., the bit width of the SRI field is no less than 1 bit), the OLPC field is 1 bit; when the SRI field is not present in the DCI, the OLPC field is 1 bit or 2 bits configured to the UE by a high layer parameter (e.g., by a parameter olpc-ParameterSetDCI-0-1 indicating the bit width of OLPC field in DCI format 0_1 or by a parameter olpc-ParameterSetDCI-0-2 for DCI format 0_2 as specified in 3GPP standard documents). When an SRS resource set used for CB or nCB based PUSCH transmission contains only one SRS resource, the SRI field may be absent (or not present) in the DCI. In some embodiments, the SRI field being not present in the DCI format 0_1 or DCI format 0_2 may also refer to the SRI field being not valid in the DCI or the SRI field being 0 bit.

In Rel-17, in addition to the high layer parameter p0-PUSCH-SetList introduced in Rel-16, another p0-PUSCH-SetList is introduced for another TRP to support the M-TRP based PUSCH transmission. When two SRI fields are present in the DCI, one OLPC field with 1 bit is agreed in Rel-17 to indicate the OLPC parameters for both TRPs. However, since the numbers of SRS resources in the two SRS resource sets may be different, there may be a case that an SRI field is present and the other SRI field is absent in the DCI. In such case, the number of OLPC fields and the bit width of each OLPC field need to be determined.

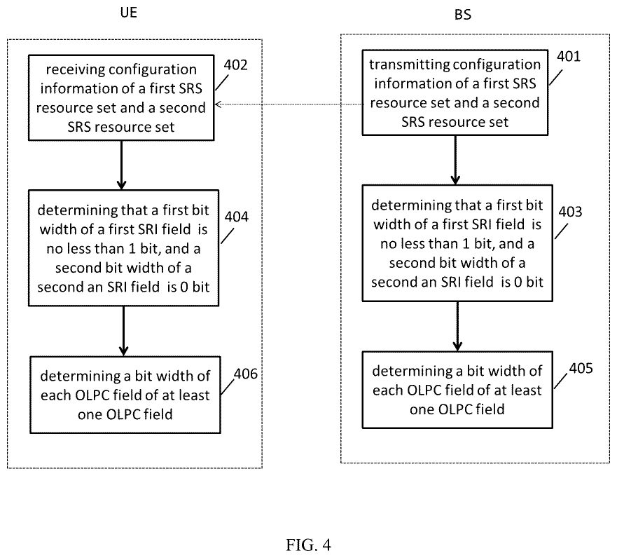

FIG. 4 illustrates a flow chart of an exemplary method for M-TRP based PUSCH transmission according to some embodiments of the present application. Although the method is illustrated in a system level by a UE and a BS (e.g., UE 105 and BS 101 as illustrated and shown in FIG. 1), persons skilled in the art can understand that the method implemented in the UE and that implemented in the BS can be separately implemented and incorporated by other apparatus with the like functions.

As shown in FIG. 4, in step 401, the BS may transmit configuration information of a first SRS resource set and a second SRS resource set for a PUSCH transmission to the UE. The first SRS resource set may refer to the SRS resource set with a lower index or ID (e.g., SRS-ResourceId as specified in 3GPP standard documents), and the second SRS resource set may refer to the SRS resource set with a higher index or ID. The first SRS resource set may be used for at least one PUSCH transmission towards a first TRP (e.g., TRP #1), and the second SRS resource set may be used for at least one PUSCH transmission towards a second TRP (e.g., TRP #2). Each of the first SRS resource set and the second SRS resource set may include at least one SRS resource.

Consequently, in step 402, the UE may receive the configuration information of the first SRS resource set and the second SRS resource set from the BS.

In some embodiments of the present application, one SRS resource set of the first SRS resource set and the second SRS resource set may include more than one SRS resource, and the other SRS resource set of the first SRS resource set and the second SRS resource set may include only one SRS resource.

Accordingly, after receiving the configuration information, in step 404, the UE may determine that a first bit width of an SRI field in DCI associated with the one SRS resource set (which includes more than one SRS resource) is no less than 1 bit, and a second bit width of an SRI field in the DCI associated with the other SRS resource set (which includes only one SRS resource) is 0 bit. The DCI may be DCI format 0_1 or DCI format 0_2 as specified in the 3GPP standard documents.

Similarly, after transmitting the configuration information, in step 403, the BS may also determine that the first bit width of the SRI field in the DCI associated with the one SRS resource set (which includes more than one SRS resource) is no less than 1 bit, and the second bit width of the SRI field in the DCI associated with the other SRS resource set (which includes only one SRS resource) is 0 bit. The DCI may be DCI format 0_1 or DCI format 0_2 as specified in the 3GPP standard documents. The SRI field with the first bit width of no less than 1 bit may also be referred to as the SRI field present or valid in the DCI. The SRI field with the second bit width of 0 bit may also be referred to as the SRI field absent, invalid, or not present in the DCI. Step 404 and step 403 can be performed independently at the UE and the BS, respectively.

Then, in step 406, the UE may determine a bit width of each OLPC field of at least one OLPC field in the DCI when a first p0-PUSCH-SetList (e.g., p0-PUSCH-SetList-r16) associated with the one SRS resource set (which includes more than one SRS resource) and a second p0-PUSCH-SetList (e.g., another p0-PUSCH-SetList-r16) associated with the other SRS resource set (which includes only one SRS resource) are configured to the UE. In step 405, the BS may use the same method as that used by the UE to determine the bit width of each OLPC field of at least one OLPC field in the DCI when the first p0-PUSCH-SetList and the second p0-PUSCH-SetList are configured, which will be described below. A high layer may refer to a layer higher than the physical layer (e.g., a radio resource control (RRC) layer). Also, step 406 and step 405 can be performed independently at the UE and the BS, respectively.

According to some embodiments of the present application, the DCI includes only one OLPC field.

In an embodiment of the present application, when only one SRI field is present in the DCI and the UE is configured with the first p0-PUSCH-SetList corresponding to the one SRS resource set (which includes more than one SRS resource) and the second p0-PUSCH-SetList corresponding to the other SRS resource set (which includes only one SRS resource), the bit width of the OLPC field may be determined by always following the case that both SRI fields are present in the DCI, i.e., the bit width of the OLPC field is 1 bit.

In such embodiment, the OLPC field being “0” indicates that: (1) an OLPC parameter (e.g., “P0” as specified in 3GPP standard documents) for a PUSCH transmission according to the one SRS resource set (which includes more than one SRS resource) is determined from an SRI-PUSCH-PowerControl (which is used to configure a set of power control parameters for PUSCH transmission, where each SRI-PUSCH-PowerControl is mapped to an SRI field value) corresponding to the one SRS resource set with an SRI-PUSCH-PowerControl ID or index (e.g., sri-PUSCH-PowerControlId as specified in 3GPP standard documents) mapped to a value of the SRI field with no less than 1 bit; and/or (2) an OLPC parameter for a PUSCH transmission according to the other SRS resource set (which includes only one SRS resource) is determined by a first P0-PUSCH-AlphaSet in p0-AlphaSets (which is a list of P0-PUSCH-AlphaSet for configuring a P0 and an alpha parameter) corresponding to the other SRS resource set. The OLPC field being “1” indicates that: (1) an OLPC parameter (e.g., “P0-PUSCH-r16” as specified in 3GPP standard documents which is introduced in Rel-16 for configuring a target receive power at a BS) for a PUSCH transmission according to the one SRS resource set is determined by a first value in a P0-PUSCH-Set (e.g., p0-PUSCH-Set-r16 as specified in 3GPP standard documents, which is a list of up to two P0-PUSCH-r16 and each P0-PUSCH-Set-r16 is mapped to an SRI field value) with a p0-PUSCH-Set ID or index (e.g., p0-PUSCH-SetId-r16 as specified in 3GPP standard documents) mapped to the value of the SRI field with no less than 1 bit in the first p0-PUSCH-SetList corresponding to the one SRS resource set; and/or (2) an OLPC parameter for a PUSCH transmission according to the other SRS resource set is determined by a first value in a P0-PUSCH-Set with the lowest p0-PUSCH-SetId in the second p0-PUSCH-SetList corresponding to the other SRS resource set. The first value may refer to the first one configured in a list.

The following Table 5 provides example codepoints of an OLPC field being 1 bit. In Table 5, it is assumed that the first SRI field associated with the first SRS resource set (i.e., for TRP #1) is present and the second SRI field associated with the second SRS resource set (i.e., for TRP #2) is absent in DCI. For different codepoints, the OLPC parameter (e.g., “P0”) for PUSCH transmission towards TRP #1 and TRP #2 may be determined as shown in Table 5.

TABLE 5
codepoints of an OLPC field being 1 bit

| OLPC | For TRP#1 (the SRI | For TRP #2 (the SRI |
|---|---|---|
| Codepoint | field present in DCI) | field absent in DCI) |
| 0 | P0 is determined from-SRI- | P0 is determined by a first |
| | PUSCH-PowerControl associated | P0-PUSCH-AlphaSet in p0- |
| | with TRP #1 with a sri-PUSCH- | AlphaSets associated with |
| | PowerControlId value mapped | TRP #2 |
| | to the first SRI field value | |
| 1 | P0 is determined by a first | P0 is determined by a first |
| | value in P0-PUSCH-Set with a | value in P0-PUSCH-Set with |
| | p0-PUSCH-SetId value mapped | the lowest p0-PUSCH-SetId |
| | to the first SRI field value | in the associated second p0- |
| | in the associated first | PUSCH-SetList |
| | p0-PUSCH-SetList | |

For example, it is assumed that two SRS resource sets are configured for a UE for CB based PUSCH transmission, and the first SRS resource set contains two SRS resources and the second SRS resource set contains one SRS resource. In the case that the first SRI field is associated with the first SRS resource set and has a bit width determined based on N_{m,SRS}, and the second SRI field is associated with the second SRS resource set and has a bit width determined based on N_{2,SRS}, the first SRI field is 1 bit and the second SRI field is 0 bit. That is, only the first SRI field is present in the DCI.

It is further assumed that the UE is configured with a first p0-PUSCH-SetList corresponding to the first SRI field (or the first SRS resource set) and a second p0-PUSCH-SetList corresponding to the second SRI field (or the second SRS resource set), the OLPC field is 1 bit, and the value of the first SRI field is 1.

According to Table 5, when the OLPC field is “0”, for PUSCH transmission(s) based on SRS resource(s) in the first SRS resource set, the OLPC parameter “P0” may be determined from an SRI-PUSCH-PowerControl corresponding to the first SRS resource set with an sri-PUSCH-PowerControlld value of 1, which is mapped to the value (i.e., 1) of the first SRI field (it should be noted that the sri-PUSCH-PowerControlld value and the SRI field value may be not the same in some other embodiments, and the mapping between the sri-PUSCH-PowerControlld value and the SRI field value may be different in other embodiments, e.g., an sri-PUSCH-PowerControlld value may be mapped to an SRI field value having a fixed offset with respect to the sri-PUSCH-PowerControlld value); for PUSCH transmission(s) based on the SRS resource in the second SRS resource set, the OLPC parameter “P0” may be determined by the first P0-PUSCH-AlphaSet in p0-AlphaSets corresponding to the second SRS resource set (i.e., associated with the second SRI field).

When the OLPC filed is “1”, for PUSCH transmission(s) based on the SRS resource(s) in the first SRS resource set, the OLPC parameter “P0” may be determined by a first value in a P0-PUSCH-Set with a p0-PUSCH-SetId value of 1, which is mapped to the value (i.e., 1) of the first SRI field (it should be noted that mapping between the p0-PUSCH-SetId value and the SRI field value may be different in other embodiments), in the first p0-PUSCH-SetList corresponding to the first SRS resource set (i.e., associated with the first SRI field); for PUSCH transmission(s) based on the SRS resource in the second SRS resource set, the OLPC parameter “P0” may be determined by a first value in a P0-PUSCH-Set with the lowest p0-PUSCH-SetId value in the second p0-PUSCH-SetList corresponding to the second SRS resource set (i.e., associated with the second SRI field).

In another embodiment of the present application, when only one SRI field is present in the DCI and the UE is configured with the first p0-PUSCH-SetList corresponding to the one SRS resource set (which includes more than one SRS resource) and the second p0-PUSCH-SetList corresponding to the other SRS resource set (which includes only one SRS resource), the bit width of the OLPC field may be determined by always following the case that both SRI fields are not present in the DCI, i.e., the bit width of the OLPC field is up to 2 bits.

In such embodiment, the OLPC field being “00” or “0” indicates that: (1) an OLPC parameter (e.g., “P0” as specified in 3GPP standard documents) for a PUSCH transmission according to the one SRS resource set (which includes more than one SRS resource) is determined from an SRI-PUSCH-PowerControl corresponding to the one SRS resource set with an sri-PUSCH-PowerControlld value mapped to a value of the SRI field with no less than 1 bit; and/or (2) an OLPC parameter for a PUSCH transmission according to the other SRS resource set (which includes only one SRS resource) is determined by a first P0-PUSCH-AlphaSet in p0-AlphaSets corresponding to the other SRS resource set. The OLPC field being “01” or “1” indicates that: (1) an OLPC parameter (e.g., “P0-PUSCH-r16” as specified in 3GPP standard documents) for a PUSCH transmission according to the one SRS resource set is determined by a first value in a P0-PUSCH-Set with a p0-PUSCH-SetId value mapped to the value of the SRI field with no less than 1 bit in the first p0-PUSCH-SetList corresponding to the one SRS resource set; and/or (2) an OLPC parameter for a PUSCH transmission according to the other SRS resource set is determined by a first value in a P0-PUSCH-Set with the lowest p0-PUSCH-SetId value in the second p0-PUSCH-SetList corresponding to the other SRS resource set. The OLPC field being “10” indicates that: (1) an OLPC parameter for a PUSCH transmission according to the one SRS resource set is determined by a second value in the P0-PUSCH-Set with the p0-PUSCH-SetId value mapped to the value of the SRI field with no less than 1 bit in the first p0-PUSCH-SetList corresponding to the one SRS resource set; and/or (2) an OLPC parameter for a PUSCH transmission according to the other SRS resource set is determined by a second value in the P0-PUSCH-Set with the lowest p0-PUSCH-SetId value in the second p0-PUSCH-SetList corresponding to the other SRS resource set. The second value may refer to the second one in a list. The OLPC field being “11” may be reserved.

The following Table 6 provides example of codepoints of an OLPC field being 2 bits. In Table 6, it is assumed that the first SRI field associated with the first SRS resource set (i.e., for TRP #1) is present and the second SRI field associated with the second SRS resource set (i.e., for TRP #2) is absent in DCI. For different codepoints, the OLPC parameter (e.g., “P0”) for PUSCH transmission towards TRP #1 and TRP #2 may be determined as shown in Table 6.

TABLE 6
codepoints of an OLPC field being 2 bits

| OLPC | For TRP#1(the SRI | For TRP #2(the SRI |
|---|---|---|
| Codepoint | field present in DCI) | field absent in DCI) |
| 00 | P0 is determined from SRI- | P0 is determined by a first |
| | PUSCH-PowerControl associated | P0-PUSCH-AlphaSet in p0- |
| | with TRP#1 with a sri-PUSCH- | AlphaSets associated with |
| | PowerControlId value mapped | the second SRI field for |
| | to the first SRI field value | TRP #2 |
| 01 | P0 is determined by a first | P0 is determined by a first |
| | value in P0-PUSCH-Set with a | value in P0-PUSCH-Set with |
| | p0-PUSCH-SetId value mapped | the lowest p0-PUSCH-SetId |
| | to the first SRI field value | in the associated second |
| | in the associated first p0- | p0-PUSCH-SetList |
| | PUSCH-SetList | |
| 10 | P0 is determined by a second | P0 is determined by the |
| | value in P0-PUSCH-Set with a | second value in P0- |
| | p0-PUSCH-SetId value mapped | PUSCH-Set with the |
| | to the first SRI field value | lowest p0-PUSCH-SetId in |
| | in the associated first p0- | the associated second p0- |
| | PUSCH-SetList | PUSCH-SetList |
| 11 | Reserved | Reserved |

For example, it is assumed that two SRS resource sets are configured for a UE for CB based PUSCH transmission, and the first SRS resource set contains two SRS resources and the second SRS resource set contains one SRS resource. In the case that the first SRI field is associated with the first SRS resource set and has a bit width determined based on N_{m,SRS}, and the second SRI field is associated with the second SRS resource set and has a bit width determined based on N_{2,SRS}, the first SRI field is 1 bit and the second SRI field is 0 bit. That is, only the first SRI field is present in the DCI.

It is further assumed that the UE is configured with a first p0-PUSCH-SetList corresponding to the first SRI field (or the first SRS resource set) and a second p0-PUSCH-SetList corresponding to the second SRI field (or the second SRS resource set), the OLPC field is 2 bits, and the value of the first SRI field is 1.

According to Table 6, when the OLPC field is “00”, for PUSCH transmission(s) based on SRS resource(s) in the first SRS resource set, the OLPC parameter “P0” may be determined from an SRI-PUSCH-PowerControl corresponding to the first SRS resource set with an sri-PUSCH-PowerControlld value of 1, which is mapped to the value (i.e., 1) of the first SRI field (it should be noted that mapping between the sri-PUSCH-PowerControlld value and the SRI field value may be different in other embodiments); for PUSCH transmission(s) based on the SRS resource in the second SRS resource set, the OLPC parameter “P0” may be determined by the first P0-PUSCH-AlphaSet in p0-AlphaSets corresponding to the second SRS resource set (i.e., associated with the second SRI field).

When the OLPC field is “01”, for PUSCH transmission(s) based on SRS resource(s) in the first SRS resource set, the OLPC parameter “P0” may be determined by a first value in a P0-PUSCH-Set with a p0-PUSCH-SetId value of 1, which is mapped to the value (i.e., 1) of the first SRI field (it should be noted that mapping between the p0-PUSCH-SetId value and the SRI field value may be different in other embodiments), in the first p0-PUSCH-SetList corresponding to the first SRS resource set (i.e., associated with the first SRI field); for PUSCH transmission(s) based on the SRS resource in the second SRS resource set, the OLPC parameter “P0” may be determined by a first value in a P0-PUSCH-Set with the lowest p0-PUSCH-SetId value in the second p0-PUSCH-SetList corresponding to the second SRS resource set (i.e., associated with the second SRI field).

When the OLPC field is “10”, for PUSCH transmission(s) based on SRS resource(s) in the first SRS resource set, the OLPC parameter “P0” may be determined by a second value in a P0-PUSCH-Set with a p0-PUSCH-SetId value of 1, which is mapped to the value (i.e., 1) of the first SRI field, in the first p0-PUSCH-SetList corresponding to the first SRS resource set (i.e., associated with the first SRI field); for PUSCH transmission(s) based on the SRS resource in the second SRS resource set, the OLPC parameter “P0” may be determined by a second value in a P0-PUSCH-Set with the lowest p0-PUSCH-SetId value in the second p0-PUSCH-SetList corresponding to the second SRS resource set (i.e., associated with the second SRI field).

In yet another embodiment of the present application, the bit width of the OLPC field may be indicated by a high layer parameter. For example, the high layer parameter may indicate that the bit width of the OLPC field is 1 bit or 2 bits. The codepoints of the OLPC field are the same as those in Table 5 or Table 6 respectively.

In yet another embodiment of the present application, the bit width of the OLPC field may be determined by the first SRS resource set or the second SRS resource set, which is indicated by a high layer parameter. That is, the high layer parameter may indicate the bit width of the OLPC field based on the first SRS resource set or the second SRS resource set. For example, assuming that the high layer parameter indicates the bit width of the OLPC field based on an SRS resource set including only one SRS resource, the SRI field associated with the SRS resource set is 0 bit (i.e., not present in the DCI), and thus the OLPC field is 1 bit or 2 bits as specified in 3GPP standard documents. In another example, assuming that the high layer parameter indicates the bit width of the OLPC field based on an SRS resource set including more than one SRS resource, the SRI field associated with the SRS resource set is no less than 1 bit (i.e., present in the DCI), and thus the OLPC field is 1 bit as specified in 3GPP standard documents.

In yet another embodiment of the present application, the bit width of the OLPC field may be determined by the first SRS resource set or the second SRS resource set, which is determined by a pre-defined rule. That is, the pre-defined rule may indicate to use the first SRS resource set or the second SRS resource set to determine the bit width of the OLPC field.

According to some other embodiments of the present application, the DCI may include two OLPC fields. In such embodiments, the bit width of each OLPC field is determined by the corresponding SRI field. That is, the OLPC field is 1 bit when the corresponding SRI field is present in the DCI, and the OLPC field is 1 bit or 2 bits when the corresponding SRI field is not present in the DCI.

For example, the DCI may include an OLPC field associated with the one SRS resource set which includes more than one SRS resource and an OLPC field associated with the other SRS resource set which includes only one SRS resource. Since the one SRS resource set includes more than one SRS resource, the SRI field associated with the one SRS resource set is present in the DCI, and the bit width of the OLPC field associated with the one SRS resource set is 1 bit. Since the other SRS resource set includes only one SRS resource, the SRI field associated with the other SRS resource set is not present in the DCI, and the bit width of the OLPC field associated with the other SRS resource set is 1 bit or 2 bits.

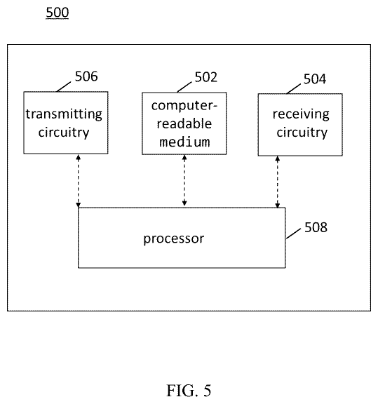

FIG. 5 illustrates a simplified block diagram of an exemplary apparatus 500 for M-TRP based transmission according to some embodiments of the present application. The apparatus 500 may be or include at least a part of a BS 101 or a UE 105 (for example, UE 105a, UE 105b, or UE 105c) as shown in FIG. 1 or other device with similar functionality.

Referring to FIG. 5, the apparatus 500 may include at least one non-transitory computer-readable medium 502, at least one receiving circuitry 504, at least one transmitting circuitry 506, and at least one processor 508. In some embodiments of the present application, the at least one receiving circuitry 504 and the at least one transmitting circuitry 506 can be integrated into at least one transceiver. The at least one non-transitory computer-readable medium 502 may have computer executable instructions stored therein. The at least one processor 508 may be coupled to the at least one non-transitory computer-readable medium 502, the at least one receiving circuitry 504 and the at least one transmitting circuitry 506. In some embodiments, the at least one processor 508, the at least one non-transitory computer-readable medium 502, the at least one receiving circuitry 504 and the at least one transmitting circuitry 506 may be coupled via a bus. The computer executable instructions can be programmed to implement any method as described in the present application (e.g., the method shown in FIG. 2 or FIG. 4) with the at least one receiving circuitry 504, the at least one transmitting circuitry 506 and the at least one processor 508.

For example, the apparatus 500 can be a UE. The computer executable instructions, when executed by the at least one processor 508, can cause the apparatus 500 to receive, with the at least one receiving circuitry 504, configuration information of a first SRS resource set and a second SRS resource set for a PUSCH transmission, wherein each of the first SRS resource set and the second SRS resource set includes at least one SRS resource. The computer executable instructions, when executed by the at least one processor 508, can further cause the apparatus 500 to determine, with the at least one processor 508, a first bit width of a first SRI field and a second bit width of a second SRI field in DCI, wherein the first bit width is determined based on a maximum number of SRS resource(s) configured in the first SRS resource set and the second SRS resource set.

As another example, the apparatus 500 can be a UE. The computer executable instructions, when executed by the at least one processor 508, can cause the apparatus 500 to receive, with the at least one receiving circuitry 504, configuration information of a first SRS resource set and a second SRS resource set for a PUSCH transmission, wherein each of the first SRS resource set and the second SRS resource set includes at least one SRS resource. The computer executable instructions, when executed by the at least one processor 508, can further cause the apparatus 500 to determine, with the at least one processor 508, that a first bit width of an SRI field associated with one SRS resource set of the first SRS resource set and the second SRS resource set is no less than 1 bit, and a second bit width of an SRI field associated with the other SRS resource set of the first SRS resource set and the second SRS resource set is 0 bit. The computer executable instructions, when executed by the at least one processor 508, can further cause the apparatus 500 to determine, with the at least one processor 508, a bit width of each OLPC field of at least one OLPC field in DCI when a first p0-PUSCH-SetList associated with the one SRS resource set and a second p0-PUSCH-SetList associated with the other SRS resource set are configured to the UE.

As another example, the apparatus 500 can be a BS. The computer executable instructions, when executed by the at least one processor 508, can cause the apparatus 500 to transmit, with the at least one transmitting circuitry 506, configuration information of a first SRS resource set and a second SRS resource set for a PUSCH transmission, wherein each of the first SRS resource set and the second SRS resource set includes at least one SRS resource. The computer executable instructions, when executed by the at least one processor 508, can further cause the apparatus 500 to determine, with the at least one processor 508, a first bit width of a first SRI field and a second bit width of a second SRI field in DCI, wherein the first bit width is determined based on a maximum number of SRS resource(s) configured in the first SRS resource set and the second SRS resource set.

As another example, the apparatus 500 can be a BS. The computer executable instructions, when executed by the at least one processor 508, can cause the apparatus 500 to transmit, with the at least one transmitting circuitry 506, configuration information of a first SRS resource set and a second SRS resource set for a PUSCH transmission, wherein each of the first SRS resource set and the second SRS resource set includes at least one SRS resource. The computer executable instructions, when executed by the at least one processor 508, can further cause the apparatus 500 to determine, with the at least one processor 508, that a first bit width of an SRI field associated with one SRS resource set of the first SRS resource set and the second SRS resource set is no less than 1 bit, and a second bit width of an SRI field associated with the other SRS resource set of the first SRS resource set and the second SRS resource set is 0 bit. The computer executable instructions, when executed by the at least one processor 508, can further cause the apparatus 500 to determine, with the at least one processor 508, a bit width of each OLPC field of at least one OLPC field in DCI when a first p0-PUSCH-SetList associated with the one SRS resource set and a second p0-PUSCH-SetList associated with the other SRS resource set are configured to a UE.

The method according to embodiments of the present application can also be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which resides a finite state machine capable of implementing the flowcharts shown in the figures may be used to implement the processor functions of this application. For example, an embodiment of the present application provides an apparatus for M-TRP based transmission, including a processor and a memory. Computer programmable instructions for implementing a method for M-TRP based transmission are stored in the memory, and the processor is configured to perform the computer programmable instructions to implement the method for M-TRP based transmission. The method for M-TRP based transmission may be any method as described in the present application.

An alternative embodiment preferably implements the methods according to embodiments of the present application in a non-transitory, computer-readable storage medium storing computer programmable instructions. The instructions are preferably executed by computer-executable components preferably integrated with a network security system. The non-transitory, computer-readable storage medium may be stored on any suitable computer readable media such as RAMs, ROMs, flash memory, EEPROMs, optical storage devices (CD or DVD), hard drives, floppy drives, or any suitable device. The computer-executable component is preferably a processor but the instructions may alternatively or additionally be executed by any suitable dedicated hardware device. For example, an embodiment of the present application provides a non-transitory, computer-readable storage medium having computer programmable instructions stored therein. The computer programmable instructions are configured to implement a method for M-TRP based transmission according to any embodiment of the present application.

While this application has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the application by simply employing the elements of the independent claims. Accordingly, embodiments of the application as set forth herein are intended to be illustrative, not limiting. Various changes may be made without departing from the spirit and scope of the application.

1. A method performed by a user equipment (UE), the method comprising:
receiving configuration information of a first sounding reference signal (SRS) resource set and a second SRS resource set for a physical uplink shared channel (PUSCH) transmission, wherein each of the first SRS resource set and the second SRS resource set comprises at least one SRS resource; and
determining a first bit width of a first SRS resource indicator (SRI) field and a second bit width of a second SRI field in downlink control information (DCI), wherein the first bit width is determined based on a maximum number of SRS resource(s) configured in the first SRS resource set and the second SRS resource set, N_{m,SRS}.

2. The method of claim 1, further comprising:
receiving a PUSCH mode field in the DCI indicating whether the PUSCH transmission is transmitted according to the first SRS resource set, the second SRS resource set, or both the first SRS resource set and the second SRS resource set.

3. The method of claim 2, wherein the second bit width is determined based on N_{m,SRS}.

4. The method of claim 2, wherein in the case that the PUSCH mode field indicates that the PUSCH transmission is transmitted according to both the first SRS resource set and the second SRS resource set, the first SRI field is associated with the first SRS resource set and the second SRI field is associated with the second SRS resource set.

5. The method of claim 4, wherein the PUSCH mode field value being “10” indicates that the PUSCH transmission is first based on the SRS resource(s) in the first SRS resource set and then based on the SRS resource(s) in the second SRS resource set, and the PUSCH mode field value being “11” indicates that the PUSCH transmission is first based on the SRS resource(s) in the second SRS resource set and then based on the SRS resource(s) in the first SRS resource set.

6. The method of claim 4, wherein the second bit width is determined based on a number of SRS resource(s) in the second SRS resource set, N_{2,SRS}.

7. The method of claim 1, further comprising:
determining that the first bit width of the SRI field associated with one SRS resource set of the first SRS resource set and the second SRS resource set is no less than 1 bit, and the second bit width of the SRI field associated with the other SRS resource set of the first SRS resource set and the second SRS resource set is 0 bit; and
determining a bit width of each open loop power control (OLPC) field of at least one OLPC field in the DCI when a first p0-PUSCH-SetList associated with the one SRS resource set and a second p0-PUSCH-SetList associated with the other SRS resource set are configured to the UE.

8. The method of claim 7, wherein the DCI includes only one OLPC field.

9. The method of claim 8, wherein the bit width of the OLPC field is one of 1 bit and 2 bits.

10.-14. (canceled)

15. A user equipment (UE) comprising:
at least one non-transitory computer-readable medium having computer executable instructions stored therein;
at least one receiving circuitry;
at least one transmitting circuitry; and
at least one processor coupled to the at least one non-transitory computer-readable medium, the at least one receiving circuitry, and the at least one transmitting circuitry, wherein the computer executable instructions configure the at least one processor to:
receive configuration information of a first sounding reference signal (SRS) resource set and a second SRS resource set for a physical uplink shared channel (PUSCH) transmission, wherein each of the first SRS resource set and the second SRS resource set comprises at least one SRS resource; and
determine a first bit width of a first SRS resource indicator (SRI) field and a second bit width of a second SRI field in downlink control information (DCI), wherein the first bit width is determined based on a maximum number of SRS resource(s) configured in the first SRS resource set and the second SRS resource set, N_{m,SRS}.

16. The UE of claim 15, wherein further the at least one processor:
receives a PUSCH mode field in the DCI indicating whether the PUSCH transmission is transmitted according to the first SRS resource set, the second SRS resource set, or both the first SRS resource set and the second SRS resource set.

17. The UE of claim 16, wherein the second bit width is determined based on N_{m,SRS}.

18. The UE of claim 16, wherein in the case that the PUSCH mode field value indicates that the PUSCH transmission is transmitted according to both the first SRS resource set and the second SRS resource set, the first SRI field is associated with the first SRS resource set and the second SRI field is associated with the second SRS resource set.

19. The UE of claim 18, wherein the PUSCH mode field value being “10” indicates that the PUSCH transmission is first based on the SRS resource(s) in the first SRS resource set and then based on the SRS resource(s) in the second SRS resource set, and the PUSCH mode field value being “11” indicates that the PUSCH transmission is first based on the SRS resource(s) in the second SRS resource set and then based on the SRS resource(s) in the first SRS resource set.

20. The UE of claim 18, wherein the second bit width is determined based on a number of SRS resource(s) in the second SRS resource set, N_{2,SRS}.

21. The UE of claim 15, wherein further the at least one processor:
determines that the first bit width of the SRI field associated with one SRS resource set of the first SRS resource set and the second SRS resource set is no less than 1 bit, and the second bit width of the SRI field associated with the other SRS resource set of the first SRS resource set and the second SRS resource set is 0 bit; and
determines a bit width of each open loop power control (OLPC) field of at least one OLPC field in the DCI when a first p0-PUSCH-SetList associated with the one SRS resource set and a second p0-PUSCH-SetList associated with the other SRS resource set are configured to the UE.

22. The UE of claim 1, wherein the DCI includes only one OLPC field.

23. The UE of claim 22, wherein the bit width of the OLPC field is one of 1 bit or 2 bits.

24. A base station comprising:
at least one receiving circuitry;
at least one transmitting circuitry;
at least one non-transitory computer-readable medium having computer executable instructions stored therein; and
at least one processor coupled to the at least one receiving circuitry, the at least one transmitting circuitry, and the at least one non-transitory computer-readable medium, wherein the computer executable instructions configure the at least one processor to:
transmit configuration information of a first sounding reference signal (SRS) resource set and a second SRS resource set for a physical uplink shared channel (PUSCH) transmission, wherein each of the first SRS resource set and the second SRS resource set comprises at least one SRS resource; and
determine a first bit width of a first SRS resource indicator (SRI) field and a second bit width of a second SRI field in downlink control information (DCI), wherein the first bit width is determined based on a maximum number of SRS resource(s) configured in the first SRS resource set and the second SRS resource set, N_{m,SRS}.

25. The base station of claim 24, wherein further the processor:
determines that the first bit width of the SRI field associated with one SRS resource set of the first SRS resource set and the second SRS resource set is no less than 1 bit, and the second bit width of the SRI field associated with the other SRS resource set of the first SRS resource set and the second SRS resource set is 0 bit; and
determines a bit width of each open loop power control (OLPC) field of at least one OLPC field in the DCI when a first p0-PUSCH-SetList associated with the one SRS resource set and a second p0-PUSCH-SetList associated with the other SRS resource set are configured to a user equipment (UE).
